(19) United States
(12) Patent Application Publication
(10) Pub. No.: US 2014/0361978 A1
(43) Pub. Date: Dec. 11, 2014

(54) PORTABLE COMPUTER MONITORING

(71) Applicant: International Business Machines Corporation, Armonk, NY (US)

(72) Inventors: Chris Malarky, Salford (GB); Adam M. Nattrass, Manchester (GB); James W. Walker, Manchester (GB)

(73) Assignee: International Business Machines Corporation, Armonk, NY (US)

(21) Appl. No.: 14/268,440

(22) Filed: May 2, 2014

(30) Foreign Application Priority Data
Jun. 7, 2013 (GB) 1310142.3

(51) Int. Cl. G06F 3/01

(52) U.S. Cl. CPC G06F 3/01
USPC 345/156

(57) ABSTRACT

Disclosed is a method of predicting the condition of a portable computer comprising a motion sensor on a computer system, the method comprising collecting motion data from said motion sensor; periodically sending said collected motion data from the portable computer to the computer system; evaluating said motion data on the computer system; and predicting said condition from the evaluated motion data. Computer program products, a portable computer, and a system for implementing aspects of the method are also disclosed.

### FIELD OF THE INVENTION

The disclosure relates to a method of predicting the condition of a portable computer such as a laptop.

The disclosure further relates to computer program products implementing aspects of such a method.

The disclosure yet further relates to a portable computer facilitating the prediction of its condition.

The disclosure yet further relates to a computer system predicting the condition of the portable computer.

### BACKGROUND

Modern day society is heavily reliant on computer-based information technology (IT) infrastructures. Many, if not all, businesses rely on computers to conduct their business. Consequently, the unavailability of such computers; e.g., due to some form of failure of the computer, is not only inconvenient but can also have negative financial implications; e.g., missed trade.

One way of reducing the risk of such computer failures is through predictive maintenance. An example of such an approach is disclosed in U.S. Pat. No. 8,140,914 B2. A predictive failure model is used to generate a failure prediction associated with a node of a computer network by collecting sensor data from sensors on the node. This allows for a repair or backup action of the node in case of a predicted imminent failure of the node. This approach targets networks in which the nodes have a fixed location within the network.

However, in many businesses; e.g., corporate enterprises, some of the network nodes are portable nodes; i.e., portable computers such as laptops, notebooks, tablets and so on. Such a scenario for instance applies to networks comprising many remote users. In such a scenario, simply collecting sensor data indicative of the operational state of the portable computer may not provide an accurate estimate of the condition of the portable computer, such that the predictive maintenance schedule may not be accurate enough to prevent the unwanted failure of the portable computer.

EP 1 080 347 B1 discloses a diagnostic vibration data collector and analyzer which incorporates an expert system within a portable computer such as a laptop or notebook type computer. The expert system analyzes vibration data acquired via a sensor coupled to the collector/analyzer in order to diagnose a condition of the portable computer. However, this requires the presence of a dedicated sensor in the portable computer, which increases its cost. Moreover, the vibrational data can generate false positives; e.g., vibrations generated by an external source or by the casing of the portable computer, which compromises the accuracy of the predictive maintenance.

### BRIEF SUMMARY OF THE INVENTION

The disclosure seeks to provide a method of predicting the condition of a portable computer that does not require dedicated hardware components.

The disclosure further seeks to provide computer program products implementing various aspects of this method.

The disclosure yet further seeks to provide a portable computer including such a computer program product.

The disclosure yet further seeks to provide a computer system including such a computer program product for evaluating data generated by the portable computer.

According to an aspect of the disclosure, there is provided a method of predicting the condition of a portable computer comprising a motion sensor on a computer system, the method comprising collecting motion data from said motion sensor; periodically sending said collected motion data from the portable computer to the computer system; evaluating said motion data on the computer system; and predicting said condition from the evaluated motion data.

The disclosure is based on the insight that portable computers routinely include motion sensors such as a knock sensor of a hard disk drive of the portable computer, which can be used to assess the condition or operational health of the portable computer. It is well-known that the use of portable computers can vary substantially. Whereas some portable computers remain stationary for most of their operational life, other portable computers are being carried around on a daily basis, which difference in motion characteristics has a profound influence on the lifetime of the portable computer. Moreover, the motion sensor can detect sudden impacts; i.e., knocks, of the portable computer, which for instance occur when the portable computer is dropped or bumped against another object. Such knocks can also negatively affect the lifetime of the portable computer. Therefore, the motion statistics of the portable computer can provide valuable insights in the condition or operational health of the portable computer. These insights not only can be used to prevent failure of the portable computer by predictive maintenance scheduling but can also aid a user or business in deciding when the portable computer should be replaced, which thus provides the user or business with more intelligent replacement plans than the routinely adopted periodic replacement plans; e.g., 3-yearly replacement cycles, that are currently in place. Such a more intelligent replacement plan can therefore provide an effective cost saving to the user or business.

In an embodiment, the method further comprises scheduling a service, a repair or a replacement of said portable computer based on said predicted condition to avoid (component) failure of the portable computer.

In an embodiment, the portable computer further comprises at least one further sensor for determining an operating parameter of a component of the portable computer, the method further comprising collecting operational data from said at least one further sensor; periodically sending said collected operational data from the portable computer to the computer system; and evaluating said operational data on the computer system; and wherein the step of predicting said condition comprises predicting said condition from the evaluated motion and operational data. This further improves the accuracy of the prediction of the condition or operational health of the portable computer.

In an embodiment, the operational data comprises at least one of battery health data, processing element temperature data and fan speed data.

In accordance with another aspect of the disclosure, there is provided a computer program product comprising a computer-readable storage medium including computer program code which when executed on a processing element of a portable computer comprising a motion sensor implements the steps of collecting motion data from said motion sensor; and periodically sending said collected motion data from the portable computer to a remote computer system. This computer program product therefore enables a portable computer to participate in embodiments of the method of the present invention.

In an embodiment, the portable computer further comprises at least one further sensor for determining an operating parameter of a component of the portable computer, the computer-readable storage medium further including computer program code which when executed on said processing element implements the steps of collecting operational data from said at least one further sensor; and periodically sending said collected operational data from the portable computer to the remote computer system. This enables a portable computer to generate more detailed data from which its condition can be predicted.

According to another aspect of the disclosure, there is provided a computer program product comprising a computer-readable storage medium including computer program code which when executed on a processing element of a computer system implements the steps of periodically receiving the collected motion data from the computer program product for the portable computer; evaluating said motion data; and predicting the condition of the portable computer from the evaluated motion data. This computer program product therefore enables a computer system to participate in embodiments of the method of the present invention.

In an embodiment, the computer-readable storage medium further includes computer program code which when executed on said processing element implements the steps of periodically receiving the collected operational data from the computer program product for the portable computer; and evaluating said operational data; and wherein the step of predicting said condition comprises predicting said condition from the evaluated motion and operational data. This enables the computer system to generate an accurate prediction of the condition of the portable computer.

In an embodiment, the computer-readable storage medium further includes computer program code which when executed on said processing element implements the step of scheduling a service, a repair or a replacement of said portable computer based on said predicted condition to avoid unwanted failure of the portable computer.

The computer program product for the portable computer and the computer program product for the computer system may be combined onto a computer program product suite.

In accordance with another aspect of the disclosure, there is provided a portable computer comprising a motion sensor; the computer program product for the portable computer; a processing element adapted to execute said computer program product; and a network interface for connecting the portable computer to a remote computer system, wherein the processing element is adapted to periodically send the collected motion data to the remote computer system through said network interface. Such a portable computer facilitates the prediction of its condition as previously explained.

In an embodiment, the portable computer further comprises a hard disk drive, wherein the motion sensor is a knock sensor of the hard disk drive.

The portable computer may further comprise at least one further sensor for determining an operating parameter of a component of the portable computer.

In accordance with another aspect of the disclosure, there is provided a computer system comprising the computer program product for the computer system; a processing element adapted to execute the computer program code of said computer program product; and a further network interface communicatively coupled to the processing element for receiving the data collected by the portable computer of the present invention. Such a computer system implements the prediction of the condition of the portable computer as previously explained.

### BRIEF DESCRIPTION OF THE DRAWINGS

Embodiments of the present invention will now be described, by way of example only, with reference to the following drawings, in which:

FIG. 1 presents a flowchart of an aspect of a method according to an embodiment of the present invention;

FIG. 2 presents a flowchart of another aspect of a method according to an embodiment of the present invention;

FIG. 3 schematically depicts a portable computer according to an embodiment of the present invention;

FIG. 4 schematically depicts a computer system according to an embodiment of the present invention; and

FIG. 5 schematically depicts a computer network according to an embodiment of the present invention.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

In the context of the present application, where embodiments of the disclosure constitute a method, it should be understood that such a method is a process for execution by a computer; i.e., is a computer-implementable method. The various steps of the method therefore reflect various parts of a computer program; e.g., various parts of one or more algorithms.

The various embodiments of the method of the present invention may be stored on a computer program product comprising a computer-readable storage medium. The computer-readable storage medium may be any medium that can be accessed by a computer for the retrieval of digital data from said medium. Non-limiting examples of a computer-readable storage medium include a CD, DVD, flash memory card, a USB memory stick, a random access memory, a read-only memory, a computer hard disk, a storage area network, a network server, an Internet server, and so on.

In the context of the present application, a (computer) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

Embodiments of the disclosure provide a method of predicting the condition of a portable computer comprising a motion sensor on a computer system to facilitate the predictive maintenance, repair or replacement of the portable computer. Typically, this method is executed in part on the portable computer and in part on the computer system. The portable computer may be any suitable portable computing device; e.g., a laptop computer, a notebook computer, a tablet computer, and so on.

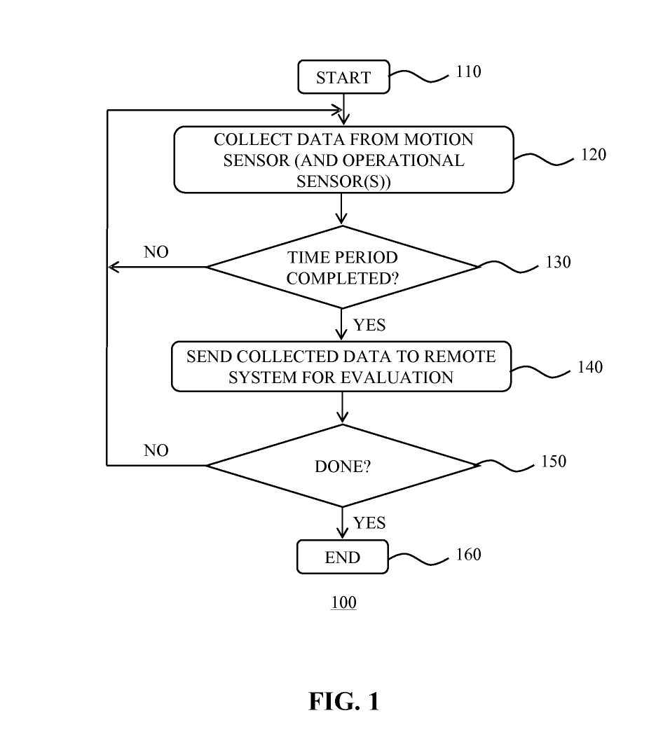

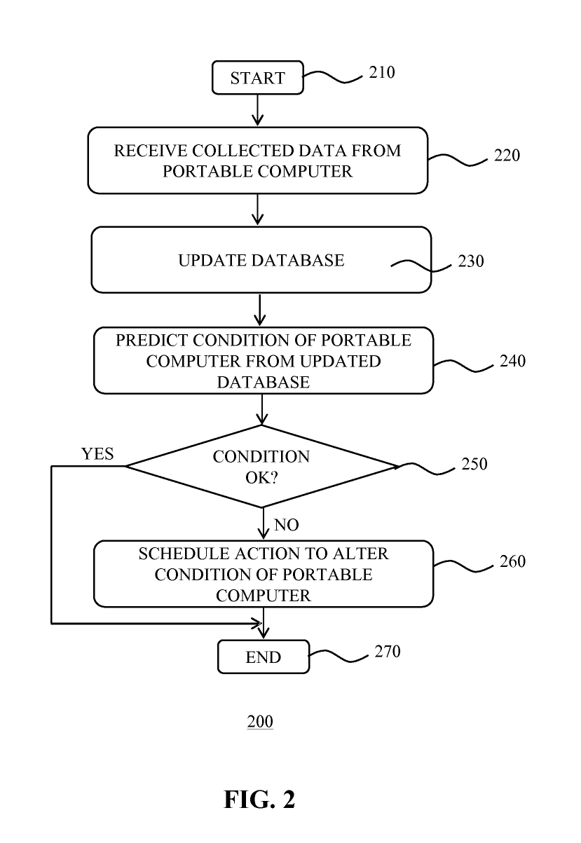

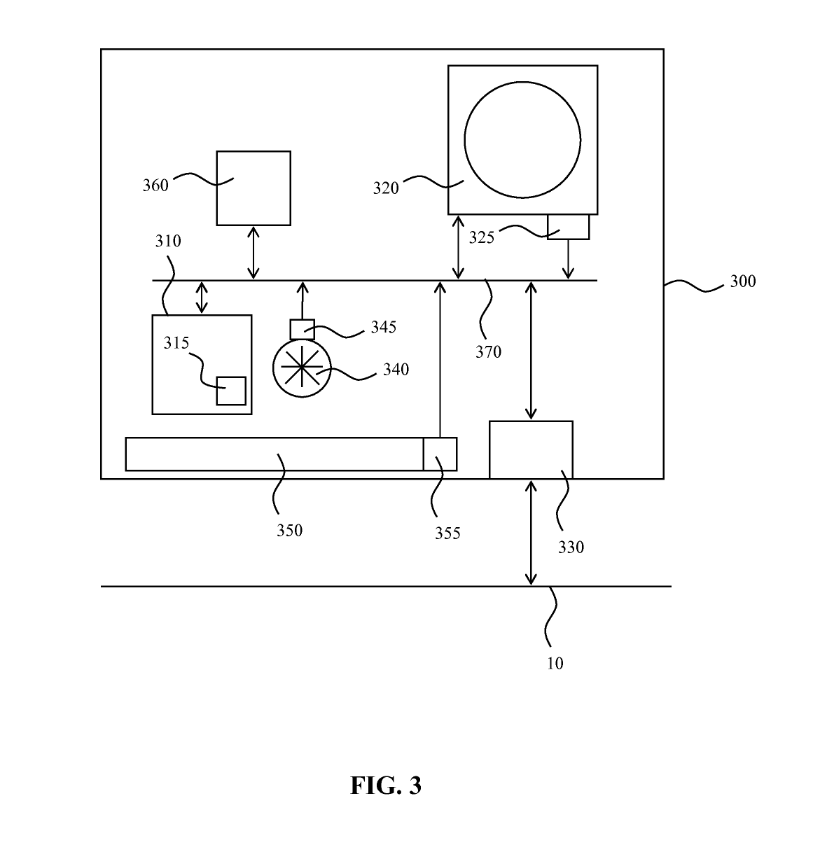

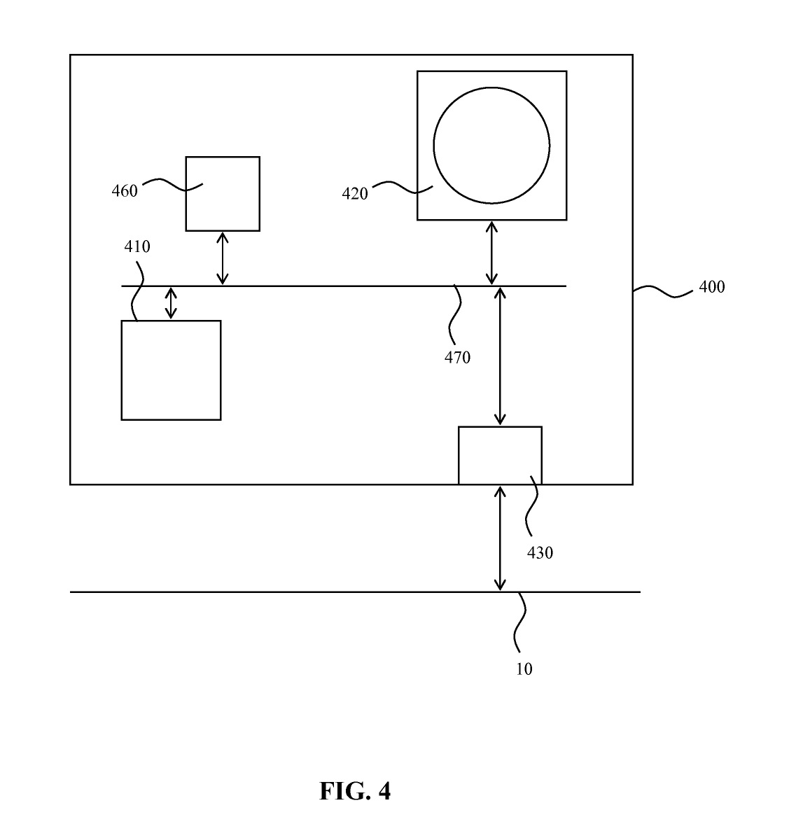

FIG. 1 depicts a flow chart of an example part of the method intended for execution on the portable computer 300, an example embodiment of which is shown in FIG. 3, whereas FIG. 2 depicts a flow chart of an example part of the method intended for execution on the computer system 400, an example embodiment of which is shown in FIG. 4.

The method 100 starts in step 110, e.g. with the power-up of the portable computer 300, which will now be described in more detail with the aid of FIG. 3. The portable computer 300 typically comprises a processing element 310; e.g., a CPU, communicatively coupled to a hard disk drive 320 if present, network interface 330 and a memory 360. The communicative coupling may be achieved in any suitable manner; e.g., using point-to-point connections (not shown), using a data communication bus 370 or a combination thereof.

The portable computer 300 further comprises a motion sensor 325, which preferably is the knock sensor of the hard disk drive 320 although it should be understood that other motion sensors; e.g., an orientation sensor of a tablet device or the like, may also be used. The portable computer 300 further comprises a fan 340 for cooling at least the processing element 310 and a battery 350 for powering the various components of the portable computer 300. It should be understood that the portable computer 300 will comprise many more components; e.g., a display screen and one or more user input devices such as a keyboard, trackball, touch pad and so on. Such additional components will be immediately apparent to the skilled person.

In an embodiment, the portable computer 300 may comprise one or more additional sensors for monitoring an operational condition of one of the components of the portable computer 300. By way of non-limiting example, FIG. 3 depicts a temperature sensor 315 for monitoring the temperature of the processing element 310, a speed sensor 345 for determining the rotation speed of the fan 340 and a battery sensor 355 for determining the health of the battery 350; e.g., its charge retention characteristics. The various sensors including the motion sensor 325 are communicatively coupled to the processing element 310 in any suitable manner; e.g., by the data communication bus 370.

Now, upon returning to FIG. 1, the method proceeds to step 120 in which the motion data generated by the motion sensor 325; e.g., the knock sensor of the hard disk drive 320, is collected by the processing element 320. The processing element 320 continues to collect the motion data until reaching the end of a defined time period, as indicated by step 130.

Upon completion of the monitoring time period, the processing element 310 transmits the collected motion data via the network interface 370 to a remote computer system 400 for evaluation in step 140.

In an embodiment, the time period is a regular time period; e.g., a time period defined as N time units, in which N is a positive integer and the time units are expressed as minutes, hours, days or any other suitable time unit. This embodiment is, for instance, appropriate if the portable computer 300 has regular or continuous access to the network 10.

In another embodiment, the time period is defined by the accessibility of the network 10. For instance, the processing element 310 of the portable computer 300 may continue to collect the motion data from the motion sensor 325 until the network 10 becomes available for the processing element 310 to transmit the motion data to the remote server 400 shown in FIG. 4.

In yet another embodiment, the time period is defined by a combination of a regular time period and the accessibility of the network 10. For instance, the processing element 310 of the portable computer 300 will continue to collect the motion data from the motion sensor 325 until completion of defined regular time period. However, if at this point the network 10 is unavailable, the processing element 310 may extend the time period or start a new time period for collecting the motion data. Once the network 10 becomes available again, the processing element 310 may transmit the collected motion data as per step 140 for one or more time periods together with an indication of the total duration of the time period. Other suitable embodiments of the time period definition will be apparent to the skilled person.

The motion data may be transmitted in any suitable form. In an embodiment, the motion data is expressed as a portion of the monitoring time period during which the portable computer 300 was in motion. In another embodiment, the motion data is expressed as a number of knocks received by the portable computer 300 during the monitored time period. In yet another embodiment, the motion data is a combination of the portion of the monitoring time period during which the portable computer 300 was in motion and the number of knocks received by the portable computer 300 during the monitored time period. Other suitable embodiments of the motion data will be apparent to the skilled person.

As indicated by step 150, the processing element 310 may subsequently start the collection of motion data for a subsequent time period, in which case the method returns to step 120. Otherwise, the method terminates in step 160; e.g., when the portable computer 300 is powered down.

In an embodiment, the portable computer 300 may comprise one or more additional sensors; e.g., temperature sensor 315, fan speed sensor 355 and/or battery sensor 355 as previously explained. In this embodiment, step 120 may further comprise collecting operational data of at least one of these additional sensors, which operational data transmitted together with the motion data to the remote computer system 400 in step 140.

The various steps of the method 100 according to one or more embodiments may be defined in terms of computer program code for execution by the processing element 310 of the portable computer 300, which code may be stored on a computer-readable medium. For example, the computer-readable storage medium may be selected from a CD, DVD, flash memory card, a USB memory stick, a random access memory, a read-only memory, a computer hard disk, a storage area network, a network server and an Internet server. Upon installation of the computer program code on the portable computer 300, the computer program code may be stored on a computer-readable storage medium of the portable computer 300, such as the hard disk drive 320 or the memory 360.

The motion data collected and transmitted by the processing element 310, optionally in combination with the operational data collected from the one or more additional sensors 315, 345 and 355 of the portable computer 300 as previously explained, is subsequently processed by a computer system 400, an example embodiment of which is shown in FIG. 4 in accordance with the example part of the method 200 shown in FIG. 2. The method 200 starts in step 210; e.g., by powering up the computer system 400, after which the method 200 proceeds to step 220 in which the motion (and operational) data transmitted by the portable computer 300 is received over the network 10; e.g., via a network interface 430 of the computer system 400. The computer system 400 may be embodied by a single computer; e.g., a single server, or by a cluster of computers; e.g., a server cluster.

As shown in FIG. 4, the computer system 400 may further comprise at least one processor element 410; e.g., one or more CPUs, communicatively coupled to the network interface 430 in any suitable manner; e.g., via a dedicated connection (not shown) or a data communication bus 470. The computer system 400 may further comprise one or more data storage devices 420; e.g., one or more hard disk drives, which may be organized in an array such as a storage area network, network-attached storage and so on. The computer system 400 may further comprise one or more memories 460. The one or more data storage devices 420 and one or more memories 460 may be communicatively coupled to the one or more processing elements 410 in any suitable manner; e.g., via respective dedicated connections (not shown), via the data communication bus 470 or a combination thereof. The one or more data storage devices 420 may have stored thereon a database containing the historical motion (and operational) data of at least one portable computer 300 as will be explained in more detail later.

Now, upon returning to FIG. 2, the method 200 proceeds to step 230, in which the database containing the historical motion (and operational) data of the portable computer 300 is updated; e.g., by adding the motion (and operational) data received in step 220 to the database or merging the historical data with the data received in step 220. In an embodiment, the historical data contains all the motion (and operational) data previously received from the portable computer 300. This, therefore, provides a complete picture of the event history of the portable computer 300.

The method subsequently proceeds to step 240 in which the one or more processing elements 410 of the computer system 400 evaluate the up to date event history; i.e., the up to date motion (and operational) data of the portable computer 300 to predict the condition of the portable computer 300. This may, for instance, be done by applying a statistical analysis to the up to date motion (and operational) data of the portable computer 300.

For example, the total amount of time that the portable computer 300 has been in motion may be determined and compared against a benchmark or threshold to determine if the portable computer 300 requires maintenance or replacing.

The total number of knocks received by the portable computer 300 may be determined and compared against a benchmark or threshold to determine if the portable computer 300 requires maintenance or replacing.

A statistical evaluation may be based on an algorithm in which the total amount of time that the portable computer 300 has been in motion as well as the total number of knocks received by the portable computer 300 is taken into consideration.

More complex evaluations may include at least one of the total amount of time that the portable computer 300 has been in motion and the total number of knocks received by the portable computer 300 in combination with at least one of the operational data sets collected by one of the operational sensors of the portable computer 300, such as the temperature sensor 315, the fan speed sensor 345 and/or the memory sensor 355. The exact implementation of such statistical evaluation algorithm is not particularly critical. Any suitable algorithm may be contemplated.

Once the condition of the portable computer 300 has been determined in step 240, the method 200 proceeds to step 250 in which it is decided if the portable computer 300 should be called in; e.g., for servicing, pre-emptive part replacement or replacement. If it is decided that the condition or operational health of the portable computer 300 has dropped below acceptable levels, the method 200 proceeds to step 260 in which the portable computer 300 is scheduled for such maintenance, repairs or replacement. Step 260 may further include sending a message to the portable computer 300 to inform its user of this scheduled activity such that the user can return the portable computer 300 to the suitable instance; e.g., a service center or corporate IT department. Such a message may be sent in any suitable form; e.g., by e-mail message or invitation, by a system message that is displayed on the desktop of the portable computer 300, by way of an automated voice call, and so on. The method subsequently terminates in step 270.

The various steps of the method 200 according to one or more embodiments may be defined in terms of computer program code for execution by the at least one processing element 410 of the computer system 400, which code may be stored on a computer-readable medium. For example, the computer-readable storage medium may be selected from a CD, DVD, flash memory card, a USB memory stick, a random access memory, a read-only memory, a computer hard disk, a storage area network, a network server and an Internet server. Upon installation of the computer program code on the computer system 400, the computer program code may be stored on a computer-readable storage medium of the computer system 400, such as the one or more hard disk drives 420 or the one or more memories 460.

In an embodiment, the computer program product for the portable computer 300 and the computer program product for the computer system 400 may be combined into a computer program product suite comprising multiple computer program products.

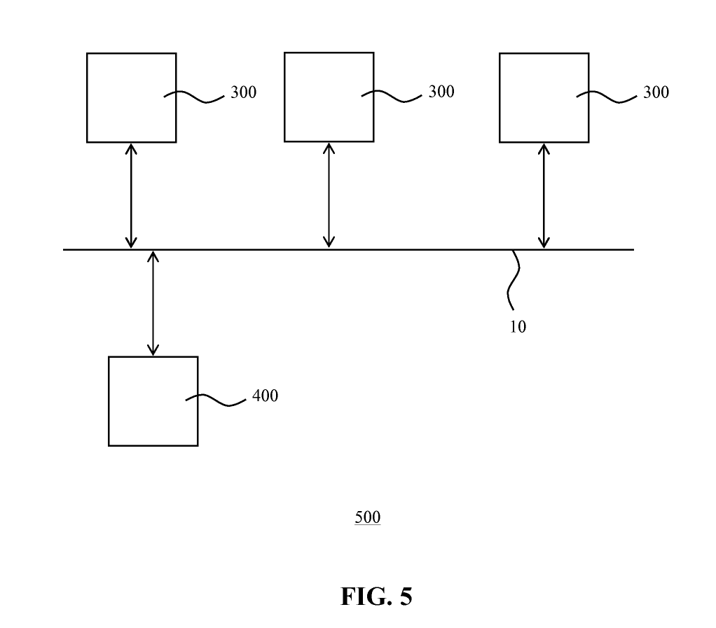

FIG. 5 schematically depicts a computer network 500 in which a plurality of portable computers 300 are communicatively coupled to the computer system 400 via the network 10. The network 10 may be a wired network; e.g., the Internet or a wireless network such as a wireless LAN, a 3G network, a 4G network, and so on. It will be obvious that the network interfaces 330 of the portable computers 300 and the network interface 430 of the computer system 400 are adapted to send and receive communications in accordance with the applicable network protocols. The computer network 500 may for instance be a corporate network in which the central computer system 400 is responsible for predictively maintaining the portable computers 300 of the corporation in accordance with embodiments of the present invention as explained in more detail above.

While particular embodiments of the disclosure have been described herein for purposes of illustration, many modifications and changes will become apparent to those skilled in the art. Accordingly, the appended claims are intended to encompass all such modifications and changes as fall within the true spirit and scope of this invention.

1. A method of predicting the condition of a portable computer comprising a motion sensor on a computer system, the method comprising:
collecting motion data from said motion sensor;
periodically sending said collected motion data from the portable computer to the computer system;
evaluating said motion data on the computer system; and
predicting said condition from the evaluated motion data.

2. The method of claim 1, wherein the motion sensor is a knock sensor of a hard disk drive of the portable computer.

3. The method of claim 1, further comprising scheduling a service, a repair or a replacement of said portable computer based on said predicted condition.

4. The method of claim 1, wherein the portable computer further comprises at least one further sensor for determining an operating parameter of a component of the portable computer, the method further comprising:
collecting operational data from said at least one further sensor;
periodically sending said collected operational data from the portable computer to the computer system; and
evaluating said operational data on the computer system; and
wherein the step of predicting said condition comprises predicting said condition from the evaluated motion and operational data.

5. The method of claim 4, wherein the operational data comprises at least one of battery health data, processing element temperature data and fan speed data.

6. A computer program product comprising a computer-readable storage medium including computer program code which when executed on a processing element of a portable computer comprising a motion sensor implements the steps of:
collecting motion data from said motion sensor; and
periodically sending said collected motion data from the portable computer to a remote computer system.

7. The computer program product of claim 6, wherein the portable computer further comprises at least one further sensor for determining an operating parameter of a component of the portable computer, the computer-readable storage medium further including computer program code which when executed on said processing element implements the steps of:
collecting operational data from said at least one further sensor; and
periodically sending said collected operational data from the portable computer to the remote computer system.

8. A portable computer comprising:
a motion sensor;
a processing element adapted to execute a computer program product comprising a computer-readable storage medium including computer program code implementing the steps of:
collecting motion data from said motion sensor; and
periodically sending said collected motion data from the portable computer to a remote computer system; and
a network interface for connecting the portable computer to a remote computer system, wherein the processing element is adapted to periodically send the collected motion data to the remote computer system through said network interface.

9. The portable computer of claim 8, further comprising a hard disk drive, and wherein the motion sensor is a knock sensor of the hard disk drive.

10. The portable computer of claim 8, further comprising at least one further sensor for determining an operating parameter of a component of the portable computer.
